(19) United States
(12) Patent Application Publication
(10) Pub. No.: US 2017/0139444 A1
(43) Pub. Date: May 18, 2017

(54) DETACHABLE POINT-OF-SALE DEVICE

(71) Applicant: EVEN SYSTEMS COMPANY LTD., Taipei City (TW)

(72) Inventors: KHAIRIL SINGGIH, City of Industry, CA (US); See-Hing TIANG, City of Industry, CA (US)

(21) Appl. No.: 14/979,581

(22) Filed: Dec. 28, 2015

(30) Foreign Application Priority Data
Nov. 18, 2015 (TW) 104218534

(51) Int. Cl. G06F 1/16

(52) U.S. Cl. CPC G06F 1/1679; G06F 1/1656; G06Q 20/20

(57) ABSTRACT

A detachable point-of-sale device has a fixed base and a portable electronic device. The fixed base has a supporting base and a connecting base that is tiltable relative to the supporting base. The portable electronic device has a connecting part that is detachably mounted on the connecting base, and a main body part that is tiltable relative to the connecting part. The fixed base can be fixed on a table, such as a checkout counter. Normally, the portable electronic device is mounted on the fixed base to be used as an ordinary point-of-sale device. A screen on the main body part can be tilted in two directions. When the portable electronic device is separated from the fixed base, the user can bring the portable electronic device to other places for use. As a result, the detachable point-of-sale device includes two operation modes.

### CROSS-REFERENCE TO RELATED APPLICATIONS

This application is based upon and claims priority under 35 U.S.C. 119 from Taiwan Patent Application No. 104218534 filed on Nov. 18, 2015, which is hereby specifically incorporated herein by this reference thereto.

### BACKGROUND OF THE INVENTION

1. Field of the Invention

The present invention relates to a point-of-sale device, especially to a point-of-sale device that is detachable from a base.

2. Description of the Prior Arts

Point-of-sale devices are common in various retailer shops nowadays for counting the sales and inventory of the goods, thereby facilitating the management of orders.

The conventional point-of-sale device is mounted securely on a table, such as a checkout counter in a convenience store to facilitate the operation and checkout work of the clerk. However, when the clerk goes into other places, such as going into a wareroom to check the goods, the clerk needs another checking device to connect the point-of-sale device wirelessly to obtain or store information. But the two devices (point-of-sale device and checking device) cost a lot, particularly to chain stores. Thus, the conventional point-of-sale device needs to be improved.

To overcome the shortcomings, the present invention provides a detachable point-of-sale device to mitigate or obviate the aforementioned problems.

### SUMMARY OF THE INVENTION

The main objective of the present invention is to provide a detachable point-of-sale device that can be mounted on a base and detach from the base to be a portable point-of-sale device.

The detachable point-of-sale device has a fixed base and a portable electronic device. The fixed base has a supporting base and a connecting base. The connecting base is mounted on a top of the supporting base and is front and rear tiltable relative to the supporting base. The portable electronic device is detachably mounted on the fixed base, and has a connecting part and a main body part. The connecting part is detachably mounted on the connecting base of the fixed base. The main body part is mounted on the connecting part, is tiltable relative to the connecting part, and has a screen. A tilting axis between the main body part and the connecting part is parallel with a normal of the screen.

The fixed base can be fixed on a table, such as a checkout counter. Normally, the portable electronic device is mounted on the fixed base to be used as an ordinary point-of-sale device. At this time, the connecting base that is tiltable relative to the supporting base enables the portable electronic device and the screen tiltable front and rear. The main body part that is tiltable relative to the connecting part enables the screen to be tilted to be in portrait or landscape display mode. In addition, when the portable electronic device is separated from the fixed base, the user can bring the portable electronic device to other places for use. As a result, the detachable point-of-sale device as described includes two operation modes, and thus the user needs not to purchase two devices, thereby lowering the cost.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a detachable point-of-sale device in accordance with the present invention, showing a fixed base and a portable electronic device assembled;

FIG. 2 is a perspective view of the detachable point-of-sale device in FIG. 1, showing the fixed base and the portable electronic device separated;

FIG. 3 is an enlarged perspective view of the detachable point-of-sale device in FIG. 1, showing the fixed base and the portable electronic device separated;

FIG. 4 is a front view of a connecting protrusion of the detachable point-of-sale device in FIG. 1;

FIG. 5 is an exploded perspective view of the portable electronic device of the detachable point-of-sale device in FIG. 1;

FIG. 6 is a front view of the detachable point-of-sale device in FIG. 1, showing a main body part not tilted relative to a connecting part;

FIG. 7 is a front view of the detachable point-of-sale device in FIG. 1, showing the main body part tilted clockwise relative to the connecting part;

FIG. 8 is a front view of the detachable point-of-sale device in FIG. 1, showing the main body part tilted counterclockwise relative to the connecting part;

FIG. 9 is a front view of the detachable point-of-sale device in FIG. 1, showing the main body part tilted to be in the portrait display mode; and

FIG. 10 is a schematic side view of the detachable point-of-sale device in FIG. 1, showing the portable electronic device tilted front and rear.

### DETAILED DESCRIPTION OF THE PREFERRED EMBODIMENTS

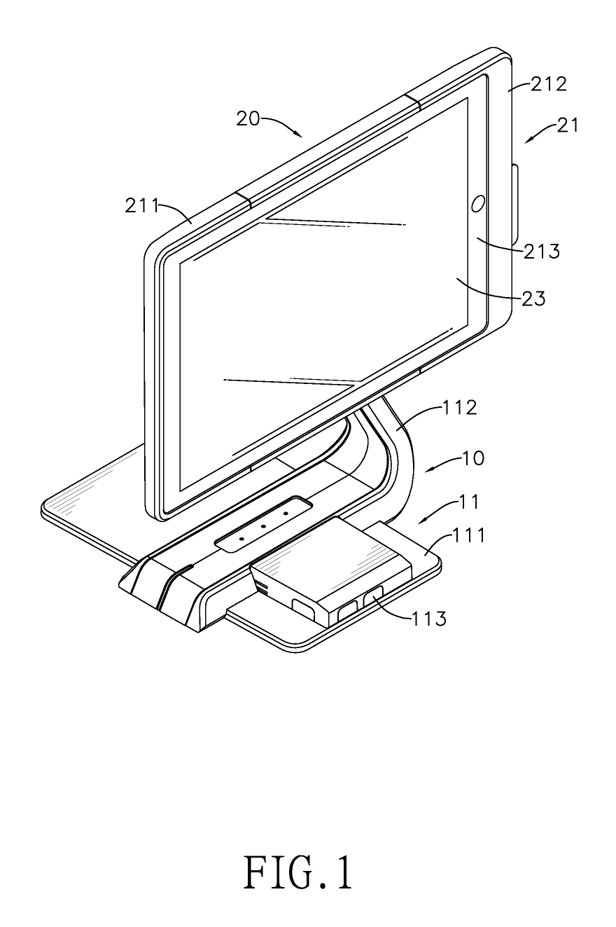

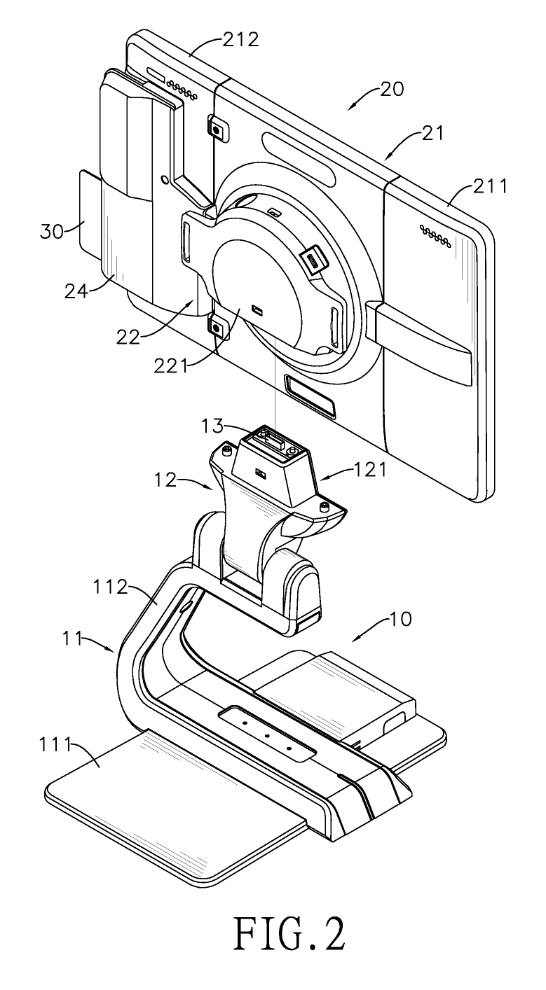

With reference to FIGS. 1 and 2, a detachable point-of-sale device in accordance with the present invention comprises a fixed base 10 and a portable electronic device 20.

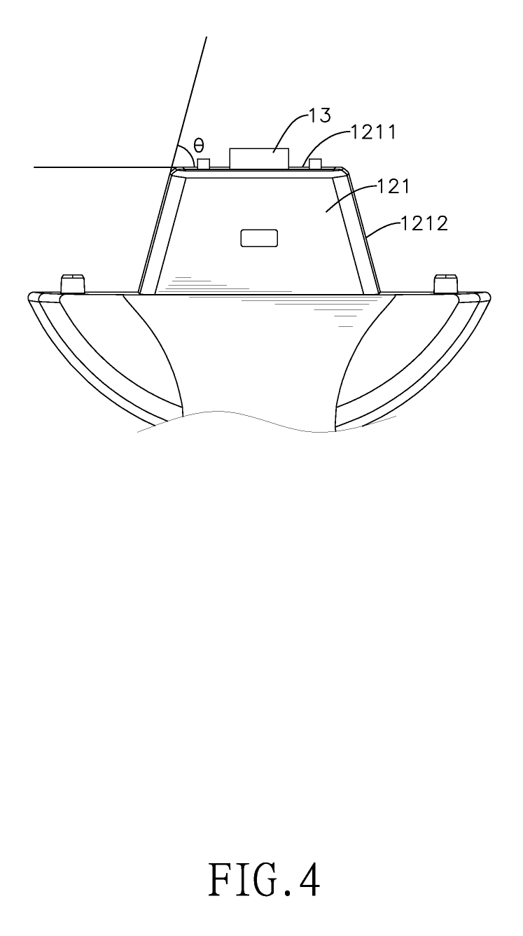

With reference to FIGS. 1 to 4, the fixed base 10 has a supporting base 11 and a connecting base 12. In a preferred embodiment, the supporting base 11 has, but not limited to, a bottom panel 111 and a curved segment 112. Multiple expansion slots 113 are formed in a front surface of the curved segment 112 and are disposed adjacent to a bottom of the curved segment 112. The expansion slots 113 may be USB (Universal Serial Bus) slots and/or power jacks. The connecting base 12 is mounted on a top end of the curved segment 112 of the supporting base 11, and is front and rear tiltable relative to the supporting base 11. In a preferred embodiment, a tilting angle of the connecting base 12 relative to the supporting base 11 is, but not limited to, 110 degrees. The connecting base 12 has a connecting protrusion 121 formed on a top end of the connecting base 12. The connecting protrusion 121 is trapezoidal and has a flat top surface 1211 and two inclined side surfaces 1212. In a preferred embodiment, an angle θ between the top surface 1211 and the inclined side surface 1212 is, but not limited to, 65 degrees as shown in FIG. 4. The connecting base 12 has a base connector 13 and two magnetic elements 122. The base connector 13 is mounted on the connecting protrusion 121 and is electrically connected to the expansion slots 113. The magnetic elements 122 are respectively disposed next to two sides of the connecting protrusion 121.

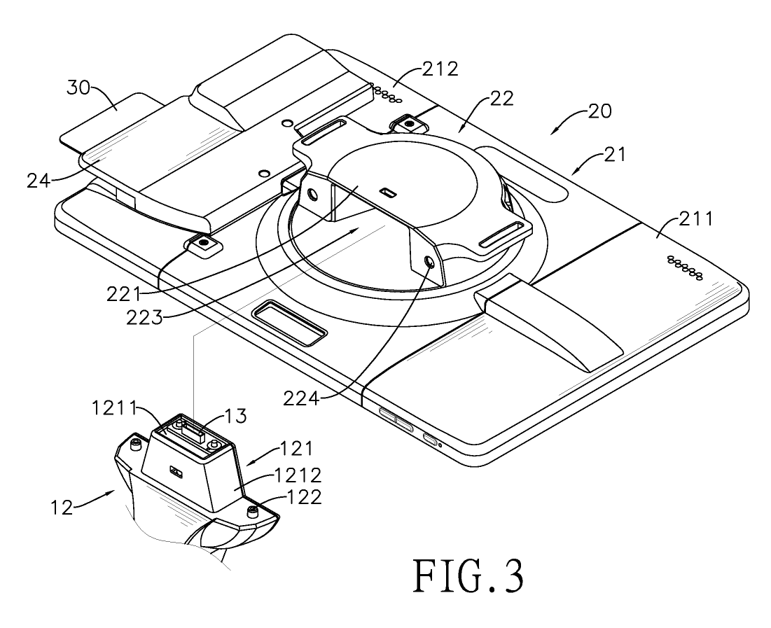

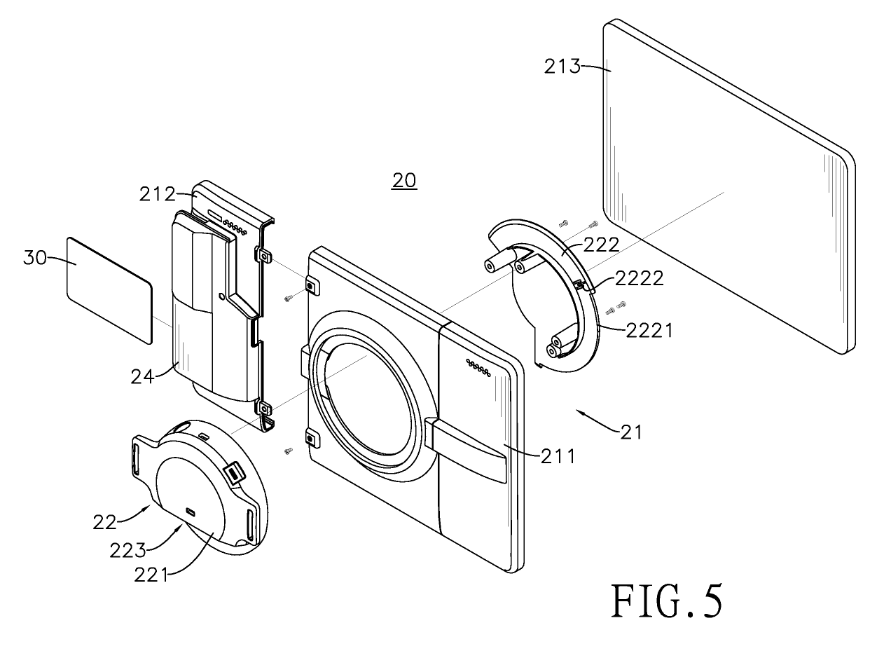

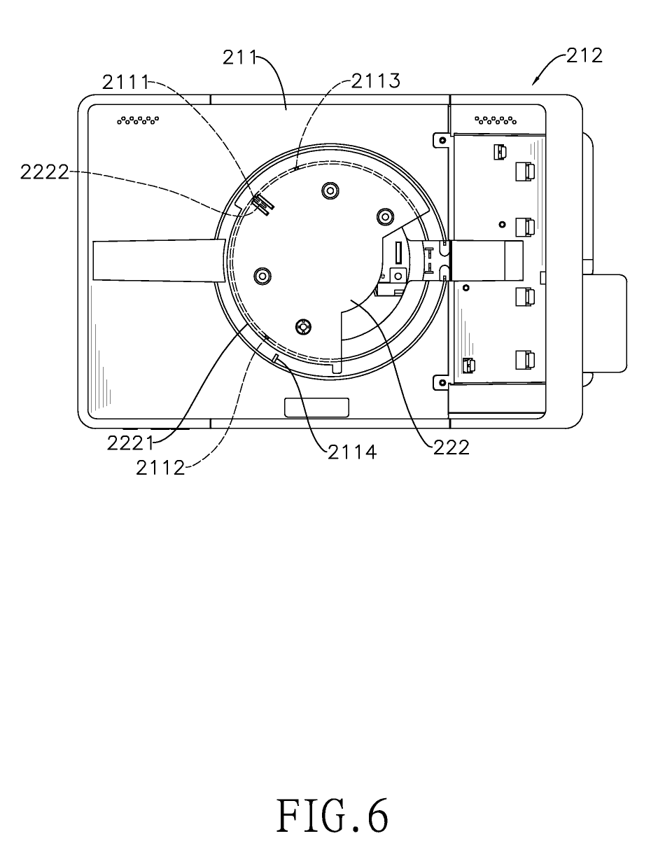

With reference to FIGS. 3, 5, and 6, the portable electronic device 20 is detachably mounted on the fixed base 10, and has a connecting part 22 and a main body part 21, which are tiltably connected to each other. The connecting part 22 is detachably mounted on the connecting base 12 of the fixed base 10, and has a stand 221 and a cover 222. The stand 221 has a connecting recess 223, a main body connector, and two magnetic elements 224. The connecting recess 223 is detachably disposed around the connecting protrusion 121, and corresponds to the connecting protrusion 121 in shape. The main body connector is mounted in the connecting recess 223. The magnetic elements 224 are respectively disposed next to two sides of the connecting recess 223. When the connecting recess 223 is disposed around the connecting protrusion 121, the main body connector is electrically connected to the base connector 13, and the two magnetic elements 224 of the portable electronic device 20 are respectively magnetically attracted to the magnetic elements 122 of the fixed base 10. At this time, the portable electronic device 20 is electrically connected to the expansion slots 113 via the main body connector and the base connector 13. A user can insert a power cord into the expansion slot 113 to indirectly charge the portable electronic device 20, or can insert an USB connector of various electronic devices into the expansion slots 113 to be electrically connected to the portable electronic device 20.

In a preferred embodiment, the magnetic elements 224 of the portable electronic device 20 and the magnetic elements 122 of the fixed base 10 are both magnets. But in another preferred embodiment, it also can be implemented that only the magnetic elements of one of the portable electronic device and the fixed base are magnets, and the magnetic elements of the other one of them are metal that can be magnetically attracted by magnet.

The cover 222 is mounted on the stand 221 has an arced recess 2221 and a positioning protrusion 2222. The arced recess 2221 extends circularly around a tilting axis between the main body part 21 and the connecting part 22, and extends for a degree equal to or larger than 90 degrees. In a preferred embodiment, the arced recess 2221 extends for, but not limited to, 120 degrees. The positioning protrusion 2222 protrudes from the cover 222 along the tilting axis between the main body part 21 and the connecting part 22.

The main body part 21 of the portable electronic device 20 is mounted on the connecting part 22, is tiltable relative to the connecting part 22, and has a first casing 211, a second casing 212 and an electronic device body 213. The first and second casings 211, 212 are assembled and cover an edge and a rear surface of the electronic device body 213. The electronic device body 213 has a screen 23 disposed in a front surface of the electronic device body 213. A normal of the screen 23 is parallel with the tilting axis between the main body part 21 and the connecting part 22. In a preferred embodiment, the screen 23 is, but not limited to, a touch screen. In another preferred embodiment, the screen may be an ordinary screen but is implemented with buttons to control.

The first casing 211 is tiltably mounted and clamped between the stand 221 and the connecting part 22, and has a limit protrusion 2114. The limit protrusion 2114 protrudes from an inner surface that is toward the electronic device body 213 of the first casing 211, is mounted in the arced recess 2221, and selectively abuts one of two side walls of the arced recess 2221 when the main body part 21 tilts relative to the connecting part 22 to limit a relative tilting angle.

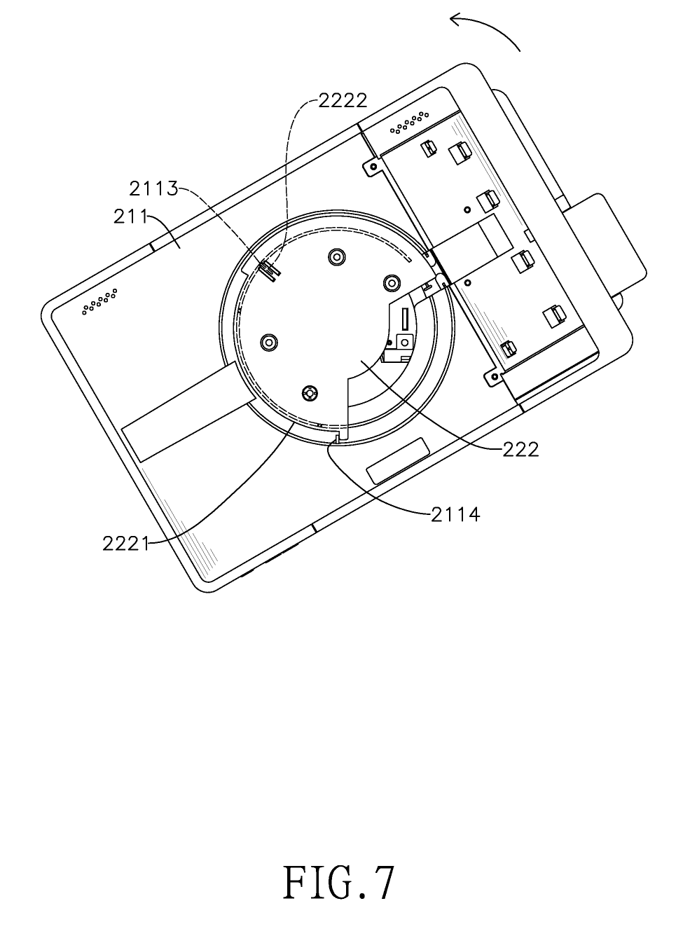

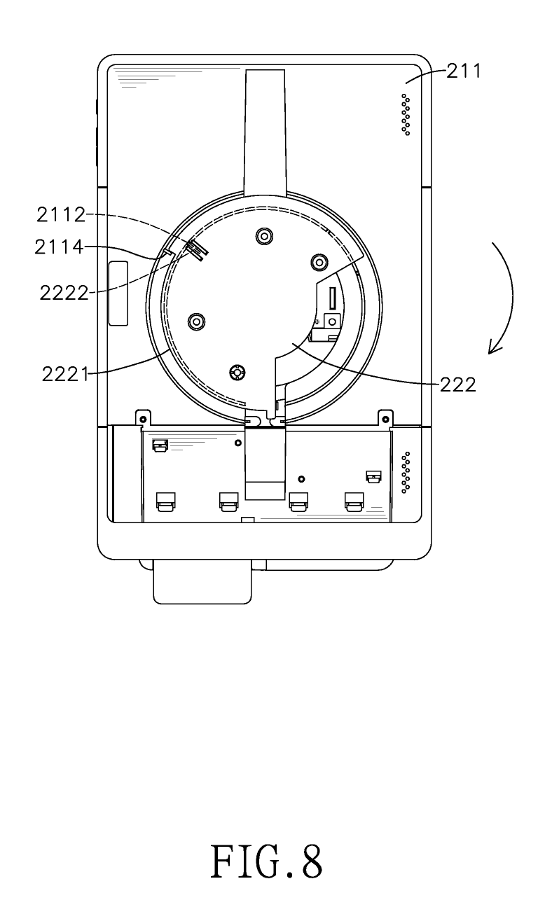

The first casing 211 has a central positioning recess 2111, a first positioning recess 2112, and a second positioning recess 2113. The positioning recesses 2111, 2112, and 2113 are formed in the inner surface that is toward the electronic device body 213 of the first casing 211, and are annularly disposed apart from one another around the tilting axis between the main body part 21 and the connecting part 22. The central positioning recess 2111 is disposed between the first positioning recess 2112 and the second positioning recess 2113. An angle between the central positioning recess 2111 and the first positioning recess 2112 is 90 degrees. An angle between the central positioning recess 2111 and the second positioning recess 2113 is from 20 to 40 degrees, and preferably is 30 degrees. The positioning protrusion 2222 of the cover 222 selectively engages in one of the positioning recesses 2111, 2112, 2113 when the main body part 21 is tilted relative to the connecting part 22. When the limit protrusion 2114 of the first casing 211 abuts the two side walls of the arced recess 2221, the positioning protrusion 2222 respectively abuts the first positioning recess 2112 and the second positioning recess 2113 as shown in FIGS. 7 and 8.

In a preferred embodiment, the portable electronic device 20 further has a card reader 24 mounted on the second casing 212 of the main body part 21 to read various cards 30. The card reader 24 may be a magnetic stripe card reader, a smart card reader or a NFC (Near Field Communication) contactless card reader for consumers to make payment with credit card, debit card or prepaid card. In another preferred embodiment, the card reader may be replaced by a scanner, and preferably a 2D Barcode scanner.

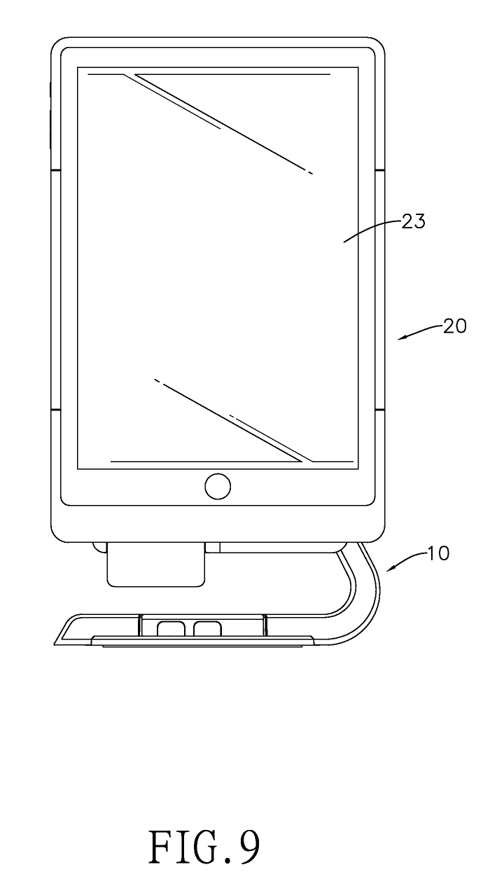

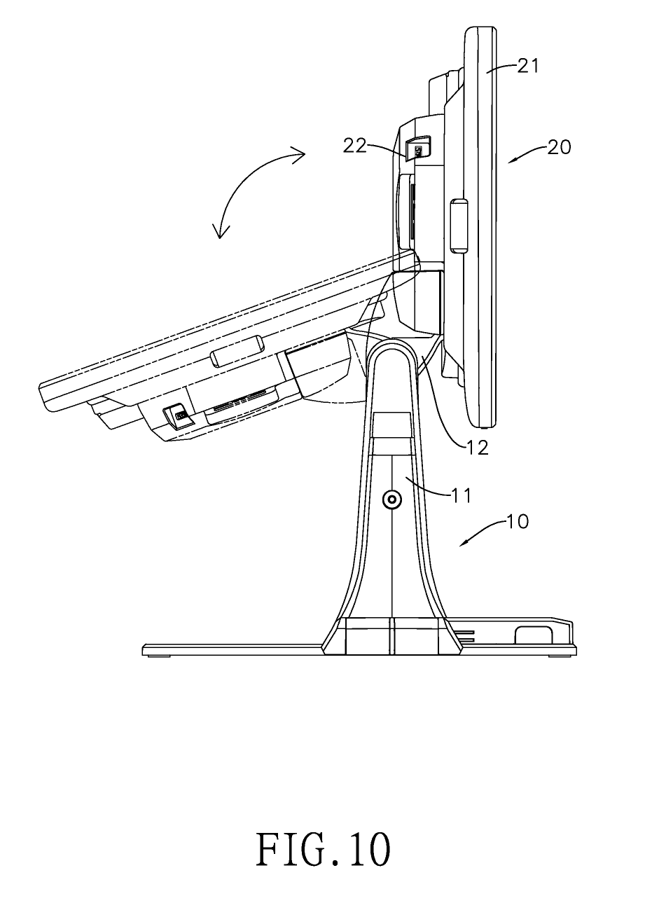

When the detachable point-of-sale device as described is in use, the fixed base 10 can be fixed on a table, such as a checkout counter. Normally, the portable electronic device 20 is mounted on the fixed base 10 to be used as an ordinary point-of-sale device. At this time, the main body part 21 may be tilted relative to the connecting part 22 to tilt the screen 23 on the main body part 21 from landscape to portrait display mode as shown in FIG. 9. The positioning protrusion 2222 is tilted from engaging with the central positioning recess 2111 to engage with the first positioning recess 2112, and the limit protrusion 2114 abuts one of the two side walls of the arced recess 2221 as shown in FIG. 8, thereby stably keeping the main body part 21 upright. In addition, the connecting base 12 may be tilted relative to the supporting base 11 to enable the screen 23 to be disposed toward the consumer as shown in FIG. 10, such that a second display device with a screen is not needed, and the consumer still can see the screen 23. In a preferred embodiment, the connecting base 12 can be tilted relative to the supporting base 11 for 110 degrees, which is the best viewing angle for the consumer.

If the user wants to operate and see the screen 23 when moving, the user just picks up the portable electronic device 20 from the fixed base 10. When holding the portable electronic device 20, the left palm of the user grabs the stand 221 of the connecting part 22, and then the main body part 21 is rotated relative to the connecting part 22 to move the positioning protrusion 2222 from engaging with the central positioning recess 2111 to engage with the second positioning recess 2113, and the limit protrusion 2114 abuts the other side wall of the arced recess 2221 as shown in FIG. 7, thereby stably keeping the main body part 21 upright. Because the angle between the central positioning recess 2111 and the second positioning recess 2113 is from 20 to 40 degrees, said angle makes the main body part 21 abut the left arm of the user to achieve the best viewing angle for the user. If the user grabs the stand 221 by the right palm, the user also can tilt the main body part 21 to abut the right arm, which also achieves the same function.

If the user wants to mount the portable electronic device 20 back to the fixed base 10, the trapezoidal connecting protrusion 121 of the connecting base 12 (particularly to the 65 degrees between the side surface 1212 and the top surface 1211 as shown in FIG. 4) and the magnetic elements 122, 224 on the fixed base 10 and the portable electronic device 20 both assist in aligning to facilitate assembling of the fixed base 10 and the portable electronic device 20.

In another preferred embodiment, the connecting protrusion also can be disposed on the portable electronic device, and the connecting recess also can be disposed on the fixed base, which also can achieve the same function.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A detachable point-of-sale device comprising:
a fixed base having
a supporting base; and
a connecting base mounted on a top of the supporting base and being front and rear tiltable relative to the supporting base; and
a portable electronic device detachably mounted on the fixed base, and having
a connecting part detachably mounted on the connecting base of the fixed base; and
a main body part mounted on the connecting part, being tiltable relative to the connecting part, and having a screen;
wherein a tilting axis between the main body part and the connecting part is parallel with a normal of the screen.

2. The detachable point-of-sale device as claimed in claim 1, wherein
the connecting base has
a connecting protrusion formed on a top end of the connecting base; and
the connecting part has
a connecting recess detachably disposed around the connecting protrusion.

3. The detachable point-of-sale device as claimed in claim 2, wherein the connecting protrusion is trapezoidal, and corresponds to the connecting recess in shape.

4. The detachable point-of-sale device as claimed in claim 1, wherein
the connecting base has at least one magnetic element;
the connecting part has at least one magnetic element; and
when the portable electronic device is mounted on the fixed base, the at least one magnetic element of the connecting base is magnetically attracted to the at least one magnetic element of the connecting part.

5. The detachable point-of-sale device as claimed in claim 1, wherein
the supporting base has at least one expansion slot;
the connecting base has a base connector electrically connected to the at least one expansion slot;
the connecting part has a main body connector; and
when the portable electronic device is mounted on the fixed base, the main body connector is electrically connected to the base connector, and the portable electronic device is electrically connected to the at least one expansion slot via the main body connector and the base connector.

6. The detachable point-of-sale device as claimed in claim 1, wherein
the connecting part has
an arced recess extending circularly around the tilting axis between the main body part and the connecting part, and extending for a degree equal to or larger than 90 degrees; and
the main body part has
a limit protrusion protruding from the main body part along the tilting axis between the main body part and the connecting part, mounted in the arced recess, and selectively abutting one of two side walls of the arced recess when the main body part tilts relative to the connecting part.

7. The detachable point-of-sale device as claimed in claim 1, wherein
the main body part has
multiple positioning recesses formed in the main body part along the tilting axis between the main body part and the connecting part, and annularly disposed apart from one another around the tilting axis between the main body part and the connecting part; and
the connecting part has
a positioning protrusion protruding from the connecting part along the tilting axis between the main body part and the connecting part, and selectively engaging with one of the positioning recesses.

8. The detachable point-of-sale device as claimed in claim 7, wherein the multiple positioning recesses include
a first positioning recess;
a second positioning recess; and
a central positioning recess disposed between the first positioning recess and the second positioning recess;
wherein an angle between the central positioning recess and the first positioning recess is 90 degrees;
wherein an angle between the central positioning recess and the second positioning recess is from 20 to 40 degrees.

9. The detachable point-of-sale device as claimed in claim 1, wherein the screen is a touch screen.

10. The detachable point-of-sale device as claimed in claim 1, wherein the portable electronic device has a card reader or a scanner.
